(19) United States
(12) Patent Application Publication
(10) Pub. No.: US 2010/0232676 A1
(43) Pub. Date: Sep. 16, 2010

(54) IMAGE SENSOR AND METHOD FOR DETECTING COUNTERFEIT BILL

(75) Inventors: Byoung-Su LEE, Yeosu-si (KR); Hee-Chan SHIN, Suwon-si (KR); Sung-Woong HAN, Guri-si (KR); Un KIM, Namyangju-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICONFILE TECHNOLOGIES INC., Seoul (KR)

(21) Appl. No.: 12/723,192

(22) Filed: Mar. 12, 2010

(30) Foreign Application Priority Data
Mar. 13, 2009 (KR) 10-2009-0021455

(51) Int. Cl. G06K 9/00

(52) U.S. Cl. 382/135

(57) ABSTRACT

An image sensor for detecting a counterfeit bill includes an ultraviolet ray emitting section for emitting ultraviolet rays to a bill to be checked; an image sensor section for acquiring a first image as an image obtained by photographing the bill to be checked in a state in which ultraviolet rays are not emitted by turning off the ultraviolet ray emitting section, and a second image as an image obtained by photographing the bill to be checked in a state in which ultraviolet rays are emitted by turning on the ultraviolet ray emitting section; a storing section for storing the first image and the second image; and a counterfeit bill detecting section for extracting a fluorescent image by removing the first image from the second image stored in the storing section and determining whether the bill to be checked is a counterfeit bill or an original bill.

### BACKGROUND OF THE INVENTION

1. Field of the Invention

The present invention relates to an image sensor and a method for detecting a counterfeit bill, and more particularly, to an image sensor and a method for detecting a counterfeit bill which can detect a counterfeit bill within a short period so that a time for a person to be exposed to ultraviolet rays can be minimized and it is possible to conveniently detect a counterfeit bill even under bright circumstances.

2. Description of the Related Art

Recently, as technical advances made in color copiers and scanners, these color copies and scanners are distributed widely throughout the world and thus it becomes easy to produce counterfeit bills. Actually, the frequency of counterfeiting accidents and the distribution amount of counterfeit bills markedly increase so that a serious social problem is caused.

In general, cashes or securities are used as prices for products and payment for services. In order to confirm whether the cashes or securities are counterfeit bills or original bills, it is the norm that inquiry is made to banking organs or a counterfeit bill detector is employed.

The conventional counterfeit bill detector, which is used in banking organs such as banks so as to detect counterfeit bills, is reliable to some extent. However, since the detector is expensive and a substantial period is required to carry out counterfeit bill detection, inconvenience can be caused to customers or clients. Also, it is difficult to distinguish a counterfeit bill with the naked eye under bright circumstances having high illuminance, which is problematic.

In order to cope with these problems, another counterfeit bill detector has been disclosed in the art, in which a fluorescent substance is inserted in a bill to have a specified pattern such that counterfeit bill detection can be carried out with the naked eye by emitting ultraviolet rays from an ultraviolet lamp to the fluorescent substance.

FIG. 1a is a perspective view illustrating a conventional counterfeit bill detector, and FIG. 1b is a sectional view taken along the line A-A′ of FIG. 1a.

Referring to FIGS. 1a and 1b, in the conventional counterfeit bill detector, a bill 1 is placed on the upper surface of a base plate 10, and ultraviolet rays are emitted to the bill 1 using ultraviolet lamps 20a and 20b. Therefore, by confirming whether or not fluorescent light is reflected from the bill 1, whether the bill 1 is a counterfeit bill or an original bill is determined.

That is to say, when an original bill and a counterfeit bill are placed under the ultraviolet lamps, due to the fact that the fluorescent substance in the original bill reflects light rays and the counterfeit bill does not reflect light rays, counterfeit bill detection can be easily carried out. Nevertheless, since the counterfeit bill detection using the conventional counterfeit bill detector is completely carried out through visual judgment by a user's naked eye, a different result can be caused in the counterfeit bill detection depending upon the expertness of a user.

Moreover, in the case of the conventional counterfeit bill detector using ultraviolet rays, an error can occur in the counterfeit bill detection even depending upon the illuminance of surrounding environment. Also, as a user's eyes are exposed for an extended period to ultraviolet rays that are harmful to the human body while carrying out a counterfeit bill detection task, the user's vision can be damaged. Further, if the user employs the counterfeit bill detector for a long time, the possibility of fire increases and excessive power consumption can result due to overheating.

### SUMMARY OF THE INVENTION

Accordingly, the present invention has been made in an effort to solve the problems occurring in the related art, and an object of the present invention is to provide an image sensor for detecting a counterfeit bill wherein a fluorescent image of a bill to be checked is extracted by removing an image of the bill photographed with ultraviolet rays not emitted from an image of the bill photographed with ultraviolet rays emitted so that counterfeit bill detection can be quickly carried out and a time for a person to be exposed to ultraviolet rays can be minimized to protect the user's vision.

Another object of the present invention is to provide a method for detecting a counterfeit bill which can quickly detect a counterfeit bill using an image sensor.

In order to achieve the first object, according to one aspect of the present invention, there is provided an image sensor for detecting a counterfeit bill, comprising an ultraviolet ray emitting section for emitting ultraviolet rays to a bill to be checked; an image sensor section for acquiring a first image as an image obtained by photographing the bill to be checked in a state in which ultraviolet rays are not emitted by turning off the ultraviolet ray emitting section, and a second image as an image obtained by photographing the bill to be checked in a state in which ultraviolet rays are emitted by turning on the ultraviolet ray emitting section; a storing section for storing the first image and the second image; and a counterfeit bill detecting section for extracting a fluorescent image by removing the first image from the second image stored in the storing section and determining whether the bill to be checked is a counterfeit bill or an original bill.

In order to achieve the second object, according to another aspect of the present invention, there is provided a method for detecting a counterfeit bill, comprising the steps of storing a first image obtained by photographing a bill to be checked in a state in which ultraviolet rays are not emitted; storing a second image obtained by photographing the bill to be checked in a state in which ultraviolet rays are emitted; extracting a third image by removing the first image from the second image; and amplifying and displaying the third image.

### BRIEF DESCRIPTION OF THE DRAWINGS

The above objects, and other features and advantages of the present invention will become more apparent after a reading of the following detailed description taken in conjunction with the drawings, in which:

FIG. 1a is a perspective view illustrating a conventional counterfeit bill detector;

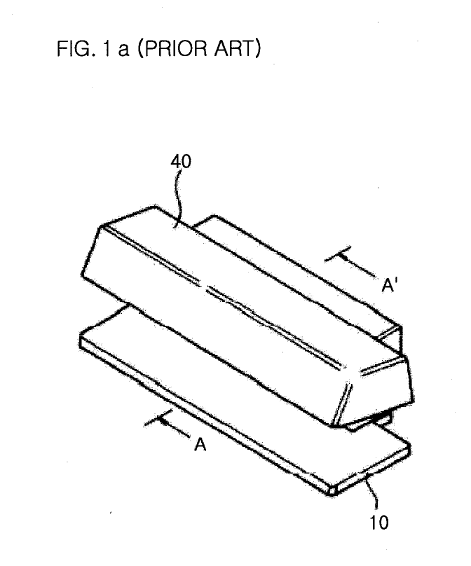

FIG. 1b is a sectional view taken along the line A-A′ of FIG. 1a;

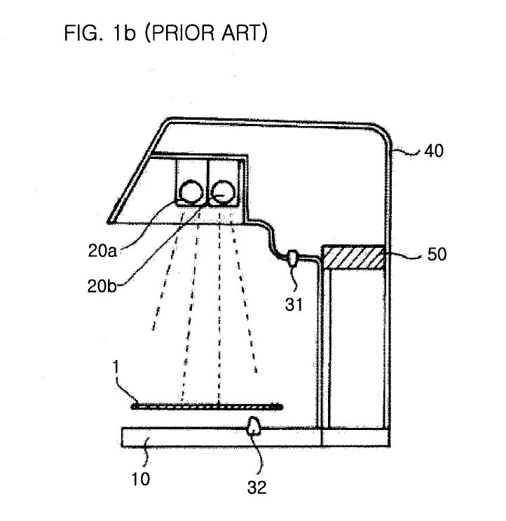

FIG. 2 is a systematic view illustrating an image sensor for detecting a counterfeit bill in accordance with an embodiment of the present invention;

FIG. 3 is a view showing the technical principle of the image sensor for detecting a counterfeit bill according to the present invention; and

FIG. 4 is a flow chart explaining a method for detecting a counterfeit bill in accordance with another embodiment of the present invention.

### DETAILED DESCRIPTION OF PREFERRED EMBODIMENTS

Reference will now be made in greater detail to preferred embodiments of the invention, examples of which are illustrated in the accompanying drawings. Wherever possible, the same reference numerals will be used throughout the drawings and the description to refer to the same or like parts.

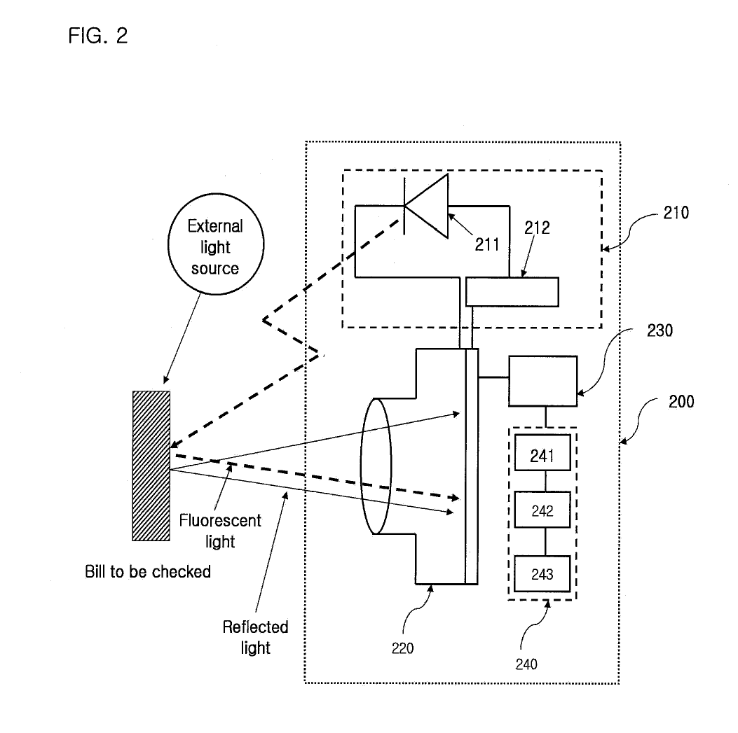

FIG. 2 is a systematic view illustrating an image sensor for detecting a counterfeit bill in accordance with an embodiment of the present invention.

Referring to FIG. 2, an image sensor 200 for detecting a counterfeit bill in accordance with an embodiment of the present invention includes an ultraviolet ray emitting section 210, an image sensor section 220, an image storing section 230, and a counterfeit bill detecting section 240.

The ultraviolet ray emitting section 210 has an ultraviolet ray emitting diode 211 and an ultraviolet ray emitting diode control unit 212. The ultraviolet ray emitting diode 211 is turned on and off under the control of the ultraviolet ray emitting diode control unit 212. The ultraviolet ray emitting diode 211 emits ultraviolet rays to a bill to be checked in response to a signal from the ultraviolet ray emitting diode control unit 212.

The image sensor section 220 acquires a first image as an image obtained by photographing the bill to be checked in a state in which ultraviolet rays are not emitted by turning off the ultraviolet ray emitting diode 211 in response to a signal from the ultraviolet ray emitting diode control unit 212, and a second image as an image obtained by photographing the bill to be checked in a state in which ultraviolet rays are emitted by turning on the ultraviolet ray emitting diode 211 in response to a signal from the ultraviolet ray emitting diode control unit 212.

Since the first image is the image of the bill which is photographed with ultraviolet rays not emitted, an fluorescent image created by a fluorescent substance inserted into the bill when manufacturing the bill is not include in the first image, and since the second image is the image of the bill which is photographed with ultraviolet rays emitted, the fluorescent image is included in the second image.

The image storing section 230 stores the first image and the second image which are acquired by the image sensor section 220.

The counterfeit bill detecting section 240 determines whether the bill to be checked is a counterfeit bill or an original bill, by using the first image and the second image which are stored in the image storing section 230. The counterfeit bill detecting section 240 includes a third image extracting unit 241, an amplifying unit 242 and a display unit 243.

The third image extracting unit 241 removes the first image not including the fluorescent image from the second image including the fluorescent image and extracts a third image as the fluorescent image inserted into the bill. The amplifying unit 242 and the display unit 243 amplifies the extracted third image and displays the amplified third image. Then, by analyzing the third image displayed on a window, it is determined whether the bill to be checked is a counterfeit bill or an original bill.

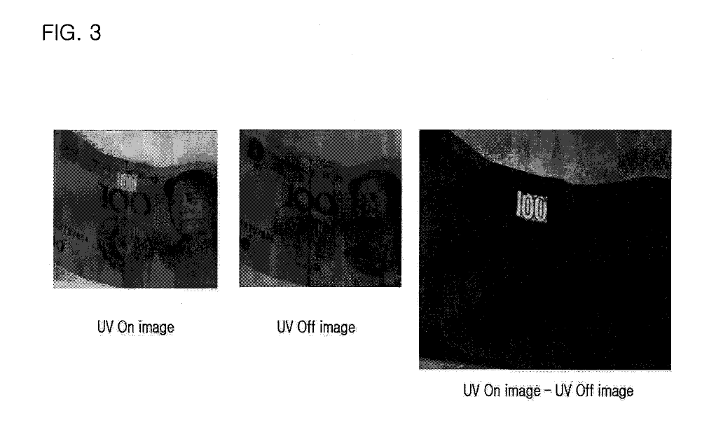

FIG. 3 is a view showing the technical principle of the image sensor for detecting a counterfeit bill according to the present invention.

As described above, by removing an image obtained with ultraviolet rays not emitted from an image obtained with ultraviolet rays emitted and extracting only a fluorescent image, counterfeit bill detection can be simply and quickly carried out.

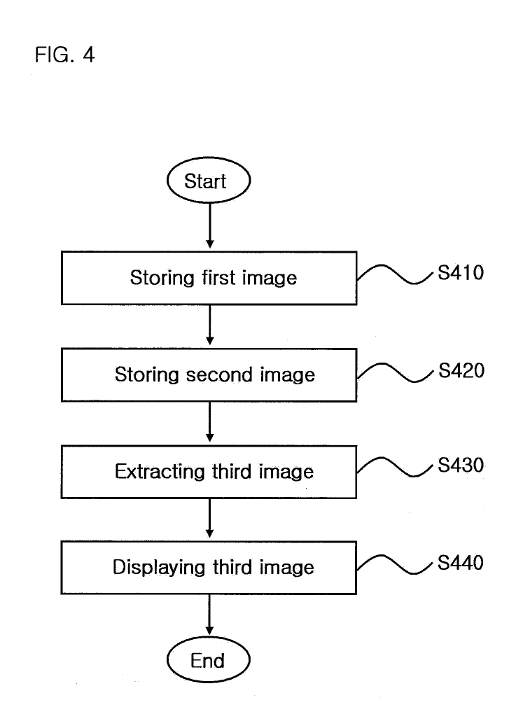

FIG. 4 is a flow chart explaining a method for detecting a counterfeit bill in accordance with another embodiment of the present invention.

Referring to FIG. 4, a method for detecting a counterfeit bill in accordance with another embodiment of the present invention includes a first image storing step (S410), a second image storing step (S420), a third image extracting step (S430), and a third image displaying step (S440).

In the first image storing step (S410), a first image obtained by photographing a bill to be checked with ultraviolet rays not emitted is stored. Therefore, a fluorescent image created by a fluorescent substance inserted into the bill is not included in the first image.

In the second image storing step (S420), a second image obtained by photographing the bill to be checked with ultraviolet rays emitted is stored. Therefore, the fluorescent image created by the fluorescent substance inserted into the bill is included in the second image.

In the third image extracting step (S430), by removing the first image not including the fluorescent image from the second image including the fluorescent image, a third image is extracted. The third image is composed of only the fluorescent image created by the fluorescent substance inserted into the bill.

In the third image displaying step (S440), the third image composed of only the fluorescent image is amplified and displayed on a window. Because the fluorescent image of the bill is clearly displayed on the window, counterfeit bill detection can be easily carried out irrespective of the illuminance of surrounding environment.

Since the second image storing step (S420) requires only a time for photographing the bill to be checked with ultraviolet rays emitted and thereby obtaining the second image, the second image storing step (S420) can be implemented within a short period less than 0.1 second. Accordingly, as the turning-on time of an ultraviolet ray emitting diode is minimized, a time for a user to be exposed to ultraviolet rays can be minimized. Also, because a difference between the signals sensed by an image sensor section (that is, between the signals sensed with ultraviolet rays emitted and not emitted) is amplified and displayed, it is possible to use a light emitting diode (LED) having low power consumption. Due to this fact, since it is not necessary to use a high output ultraviolet source for outputting fluorescent light to the extent that the fluorescent light can be sufficiently perceived by a user as in the conventional art, the cost of a system and power consumption can be reduced.

Further, in the conventional art, since at least about 10 seconds are required to carry out counterfeit bill detection with an ultraviolet lamp turned on, a user's vision is likely to be damaged. In this regard, in the present invention, since a time for a user to be exposed to ultraviolet rays is minimized, the user's vision can be protected.

As is apparent from the above description, in the image sensor and the method for detecting a counterfeit bill according to the present invention, a counterfeit bill can be detected even under bright circumstances, and counterfeit bill detection can be effected within a short period to minimize a user's exposure to ultraviolet rays so that the user's vision can be protected. Also, since the fluorescent image of a bill is clearly displayed, the counterfeit bill detection can be easily carried out.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. An image sensor for detecting a counterfeit bill, comprising:
an ultraviolet ray emitting section for emitting ultraviolet rays to a bill to be checked;
an image sensor section for acquiring a first image as an image obtained by photographing the bill to be checked in a state in which ultraviolet rays are not emitted by turning off the ultraviolet ray emitting section, and a second image as an image obtained by photographing the bill to be checked in a state in which ultraviolet rays are emitted by turning on the ultraviolet ray emitting section;
a storing section for storing the first image and the second image; and
a counterfeit bill detecting section for extracting a fluorescent image by removing the first image from the second image stored in the storing section and determining whether the bill to be checked is a counterfeit bill or an original bill.

2. The image sensor according to claim 1, wherein the counterfeit bill detecting section comprises:
a third image extracting unit for extracting a third image by removing the first image from the second image;
an amplifying unit for amplifying the extracted third image; and
a display unit for displaying the amplified third image.

3. The image sensor according to claim 2, wherein the ultraviolet ray emitting section comprises:
an ultraviolet ray emitting diode; and
an ultraviolet ray emitting diode control unit for controlling turning-on and turning-off of the ultraviolet ray emitting diode.

4. A method for detecting a counterfeit bill, comprising the steps of:
storing a first image obtained by photographing a bill to be checked in a state in which ultraviolet rays are not emitted;
storing a second image obtained by photographing the bill to be checked in a state in which ultraviolet rays are emitted;
extracting a third image by removing the first image from the second image; and
amplifying and displaying the third image.

5. The method according to claim 4, wherein the step of storing the second image is implemented within a time less than 0.1 second.
